(19) United States
(12) Patent Application Publication
(10) Pub. No.: US 2016/0231345 A1
(43) Pub. Date: Aug. 11, 2016

(54) DISPENSER FOR LIQUID SUBSTANCES

(71) Applicant: GYGER INVEST AG, Gwatt/Thun (CH)

(72) Inventors: Bernd MERZENICH, Niederkassel (DE); Fritz GYGER, Gwatt (CH)

(73) Assignee: GYGER INVEST AG, CH-3645 Gwatt/Thun (CH)

(21) Appl. No.: 15/021,908

(22) PCT Filed: Sep. 8, 2014
(86) PCT No.: PCT/EP2014/069051

§ 371 Date: Mar. 14, 2016

(51) Int. Cl. G01N 35/10; B01L 3/00; G01N 35/00

(52) U.S. Cl. CPC G01N 35/109; G01N 35/1016; G01N 35/1011; G01N 35/00871; B01L 3/502715; B01L 3/502738; B01L 3/50273; G01N 2035/1039; G01N 2035/0091; B01L 2400/0622; G01N 2035/1044; B01L 2400/0487; B01L 2200/0605; B01L 2300/0627

(57) ABSTRACT

A dispenser (100, 100′, 100″) for dispensing liquids, in particular with volumes in the nanoliter range or microliter range, the dispenser (100, 100′, 100″) including a rod-shaped housing (110), which is embodied to be held in one hand when being used by a user and a reservoir connector (130) for fluidically connecting a reservoir (200) that contains a substance that is to be dispensed. A triggering element (120) manually triggers a dispensing command and an electronically actuated dispensing valve (150) includes an open state and a closed state. The dispensing valve (150) has an inlet, which is fluidically connected to the reservoir connector (130), and an outlet wherein the dispensing valve (150) is embodied to convey the dispensing liquid from the inlet to the outlet in the open state. A valve tip (152) dispenses liquid from the dispenser (100, 100′, 100″) in the open state of the dispensing valve (150).

### BACKGROUND OF THE INVENTION

1. Field of the Invention

The present disclosure relates to dispensers for dispensing liquid substances, guide devices for such dispensers, a dispenser system having such dispensers, and methods for dispensing liquid substances.

2. Discussion of Related Art

For numerous medical, pharmacological, cytological, molecular biological, or genetic analysis methods, there is increasing need for a simple, cost-effective option for dispensing—which can be used without high equipment expense—in the metering range between approximately 500 pl (picoliters) and 2 ml (milliliters); of particular relevance is the metering range between approx. 1 nl (nanoliter) and 1 μl (microliter) in which a precise manual or manually guided electrical (=so-called “electronic”) pipetting or dispensing technique has been available up to this point. Manual or so-called “electronic” pipettes or dispensers operate according to the principle of air displacement, which is produced with either a manual pump or a pump that is driven by means of electric micro-motors. A precisely replicable metering quantity of less than 0.5 μl (microliter) and a precisely replicable resolution of less than 0.1 μl in the metering range of 0.5 μl and above cannot be achieved with such a technique and the current prior art.

In addition to the usual function of a manual pipette, i.e. collecting (=aspirating) and releasing or metering (=dispensing) liquid substances, exclusively manual dispensing from a reservoir is also increasingly relevant and in demand—particularly in the range of extremely small metering quantities in the nanoliter and microliter range.

There is also a growing demand for easy-to-use, precise, and inexpensive manual dispensing devices, which in the course of preparing and performing practical experimental work—as a component of the work flow so to speak—“automatically” also provide the detection and/or recording, documentation, and usability of the corresponding parameters and data for further scientific analysis and which make it possible by means of integrated software support to also carry out highly complex dispensing tasks (e.g. when studying the interactions of a plurality of substances) by means of comparatively simple manual actions.

Finally, the complexity of studies, assays, and method developments has increased significantly in recent years, particularly in the field of cellular and molecular biology as well as pharmacology, in which detailed manual dispensing tasks are required. Not least for cost reasons, 96-gage and 384-gage microplates with 96 and 384 wells respectively are being used with ever increasing frequency as individual dispenser targets. This results in the fact that in terms of physical and/or ergonomic feasibility and a required accuracy, purely manual dispensing is increasingly reaching its limits.

### SUMMARY OF THE INVENTION

The object of the present invention is to improve the situation in this regard by creating novel dispensers, dispenser systems, and dispensing methods. This object is attained by means of devices and methods according to the independent claims; the associated dependent claims establish exemplary embodiments with advantageous properties.

A dispenser according to the present disclosure for dispensing liquid substances, particularly with volumes in the nanoliter range or microliter range, can include:

a) an essentially rod-shaped housing, which is embodied to be held in one hand when being used by a user;

b) a reservoir connector for fluidically connecting a reservoir that contains a substance that is to be dispensed;

c) a triggering element for manually triggering a dispensing command;

d) an electronically actuated dispensing valve (150) that has an open state and a closed state; the dispensing valve (150) has an inlet, which is fluidically connected to the reservoir connector (130), and an outlet; and the dispensing valve (150) is embodied to convey the dispensing liquid from the inlet to the outlet in the open state;

e) a valve tip (152), which is fluidically coupled to the outlet of the dispensing valve (150) or constitutes part of the dispensing valve (150) and which is designed to dispense liquid from the dispenser (100, 100′, 100″) in the open state of the dispensing valve (150).

A dispenser according to the present disclosure is primarily designed so that during dispensing, the valve tip is spaced a certain distance above the dispensing target such as a well and does not dip into any liquid that is already present there. The dispensing takes place in drops or in a stream.

In one exemplary embodiment, the dispenser valve is embodied as a passively closing ball valve with a valve seat made of a mineral material and a valve ball made of a mineral material. With such a design, it is possible to achieve metering volumes in the microliter or even nanoliter range. The valve seat in this case can, for example, be made of sapphire and the valve ball can be made of ruby. The dispensing valve is electromagnetically actuated by means of a valve coil and the liquid that is to be dispensed flows directly through it. In the currentless state, the dispenser valve is passively closed by means of an elastic element such as a closing spring. The closing spring acts on a mobile armature equipped with the valve ball. With each actuation in which the valve coil is supplied with power, the mobile armature with the valve ball is magnetically attracted by the magnetic field of a stationary armature, the dispenser valve opens, and conveys pressurized liquid from the inlet to the outlet.

A detailed description of suitable dispensing valves is given in WO 2008/083509, which is hereby included in the present disclosure by reference with regard to the valve design. A suitable dispensing valve can, for example, be a microvalve of the SMLD 300 G series made by Fritz Gyger AG, located in Gwatt (Thun), Switzerland.

In one embodiment, the dispenser valve is designed for minimal dispensing volumes in the range from 10 nanoliters to 200 nanoliters. The dispensing valve can, however, also be designed for other minimal dispensing volumes, depending on the requirements.

In one exemplary embodiment, the elements that during use come into contact with the substance to be dispensed—in particular the dispenser valve—can be removed without destroying them and reinstalled again.

In one exemplary embodiment, the dispenser includes a number of dispensing valves and a corresponding number of valve tips. Such an embodiment enables parallel dispensing into a plurality of dispensing targets, e.g. into a plurality of adjacent wells in a microplate or microtiter plate.

Other exemplary and advantageous embodiments of a dispenser according to the disclosure ensue from the exemplary embodiments; the particular features disclosed here and in the exemplary embodiments can each be implemented individually or in a combination.

The present disclosure also relates to a dispenser/reservoir combination, including a dispenser according to the present disclosure and a reservoir that is designed to contain the substance to be dispensed; the reservoir includes a connection for acting on the contained substance with compressed air. The compressed air in this case provides the necessary working pressure for supplying the liquid.

The reservoir can be embodied so that the liquid or substance contained comes into direct contact with the air. The reservoir body can, however, also accommodate a piston, stopper, or the like in a sealed and movable fashion in order to separate them from each other. In lieu of compressed air, it is also possible to use another compressed gas in basically the same way.

The present disclosure also relates to a guide device for a dispenser, in particular for a dispenser according to the present disclosure. A guide device according to the present disclosure can include:

a) manually actuated kinematics with a dispenser receptacle;

b) a dispensing target holder for supporting a plurality of adjacent dispensing targets in an essentially stationary, play-free fashion relative to the kinematics; the kinematics can be designed to hold the dispenser—in particular a valve tip of the dispenser—spaced a certain distance above the dispensing target holder; and

c) a position sensor system for electronically detecting an actual position of the dispenser—and in particular of a valve tip of the dispenser—in a plane above the dispensing target holder.

In this context, the expression “manually actuated” means that the movement is not carried out by means of or aided by actuators such as motors, but instead manually by the user, who exerts the necessary force for the movement.

In one exemplary embodiment of the guide device, the manually actuated kinematics include manually actuated Cartesian x/y kinematics having an x axis and a y axis and the position sensor system includes a respective linear path measuring system for the x axis and for the y axis.

In one exemplary embodiment, the dispensing target holder is embodied in the form of a microplate holder or microtiter plate with a number of wells, e.g. 96 or 384, said wells constituting dispensing targets. Alternatively, however, the dispensing target holder can also be a holder for test tubes, for example.

In one exemplary embodiment, the guide device has a detent mechanism that engages when the dispenser—in particular a valve tip of the dispenser—is positioned above a dispensing target.

In one exemplary embodiment of such a guide device, the detent mechanism has a guide pin and a guide plate; the guide plate has a number of concave elements whose geometrical arrangement on the guide plate corresponds to the geometrical arrangement of the dispensing targets; and the guide pin is designed so that when positioning over a concave element, the pin engages in the concave element and in the engaged state, releasably blocks or impedes a movement of the kinematics. The concave elements such as recesses or blind holes can also be connected by means of grooves, thus making it easier to approach the dispensing targets, e.g. wells.

Other exemplary and advantageous embodiments of a guide device according to the present disclosure ensue from the exemplary embodiments; the particular features disclosed here and in the exemplary embodiments can each be implemented individually or in a combination.

In another exemplary embodiment of the guide device, the guide device also includes an electric drive operatively coupled to the manually actuated kinematics for moving or driving the dispenser receptacle. With a guide device embodied in this way, it is possible to move or drive the dispenser receptacle or a dispenser contained in the dispenser receptacle both manually and by means of the electric drive. As explained in greater detail below, such an embodiment enables a flexible partial automation of dispensing procedures that are to be carried out repeatedly.

The present disclosure also relates to a dispenser system including a dispenser according to the present disclosure and a guide device according to the present disclosure.

In connection with a guide device according to the present disclosure, the use of a dispenser according to the disclosure is advantageous, but not mandatory. It is likewise possible to use a different dispenser. Furthermore, the dispenser and the guide device can also be embodied in a completely or partially integral fashion. The applicant expressly reserves the right to claim separate protection for a guide device according to the present disclosure.

A dispenser system of this kind, with a for example essentially hand-held dispenser and guide device, with regard to equipment complexity, constitutes an intermediate step between a simple hand-held dispenser and a dispensing automat or dispensing robot with program-controlled and actuator-operated kinematics. In particular, the investment costs are significantly lower in comparison to a corresponding automat or robot. A control unit and/or a control computer as described below require(s) comparatively little programming effort so that a system according to the present disclosure is particularly well-suited to work or experiments with one to typically ten 96-well microplates for one experimental trial or one experimental setup. In this range, the use of a fully automated dispensing unit is often unreasonably costly (both from an expense standpoint and with regard to the programming and setup time that this entails).

Depending on the design, the danger of omitted or erroneous dispensing procedures can be practically ruled out so that the operational reliability corresponds to that of a fully automated execution. At the same time, as with a fully automated solution, it is possible to implement an automatic recording.

The present disclosure also relates to a dispenser system, including at least one dispenser according to the disclosure, as well as a control unit; the control unit is embodied for operative coupling, in particular grid-bound coupling, to the at least one dispenser. The control unit includes at least one valve control; and the at least one valve control is embodied to actuate the dispenser valve to output a dispensing volume that is preset by means of the control unit. The control unit in this case can either operate autonomously or possibly be coupled to a control computer with corresponding software.

Through the corresponding selection of the opening duration of the dispensing valve, with a given reservoir pressure and a given viscosity of the liquid, the [missing word] in a dispensing procedure can be adjusted within wide latitudes.

It is alternatively possible to trigger the dispenser valve multiple times one after the other in order to output larger volumes in a sequence, with the minimum possible dispensing volume being output with each triggering. The triggering in this case preferably takes place with a sufficiently high frequency to achieve a quasi-continuous output of the total volume. The triggering frequency can, for example, be up to 4 kilohertz (kHz) for suitable valve designs.

In one exemplary embodiment, the control unit is set up for connecting to a plurality of dispensers and the control unit includes an identification device for identifying a connected dispenser.

In one exemplary embodiment, the dispenser system also includes a guide device according to the present disclosure and the dispenser system includes a control computer. The control unit and the control computer in this case include an evaluation system for data transmitted by the position measuring system; and the control unit and control computer are embodied to compare the actual position of the dispenser—and in particular of a valve tip of the dispenser—to one or more target positions and to perform an actuation of the dispensing valve by supplying power to the valve coil only when the actual position is a target position.

Target positions can in particular be composed of the opening of one or more wells of a microplate or microtiter plate. The target position is generally not an isolated point in the geometrical sense, but instead includes an area in which the valve tip can be positioned for the dispensing.

A target position, however, only exists if a dispensing should actually take place at the relevant location, e.g. in a particular well.

Other exemplary and advantageous embodiments of a dispenser system according to the disclosure ensue from the exemplary embodiments; the particular features disclosed here and in the exemplary embodiments can each be implemented individually or in a combination.

In another aspect, the present disclosure relates to a method for dispensing liquid substances, particularly with volumes in the nanoliter range or microliter range, by means of a dispenser in at least one target position. The method can include:

a) manual positioning of the dispenser;

b) triggering of a dispensing command;

c) determining an actual position of the dispenser and in particular of a valve tip of the dispenser;

d) comparison of the actual position to the at least one target position;

e) triggering of a dispensing procedure in reaction to the metering command only if the actual position of the valve tip is a target position.

In one exemplary embodiment, the method includes a display, in particular a graphic display, of the at least one target position and/or of the actual position.

In another exemplary embodiment, the method includes the calling up of a volume that is to be dispensed at the at least one target position and the actuation of the dispenser to dispense this volume.

Other exemplary and advantageous embodiments of a method according to the present disclosure ensue from the exemplary embodiments; the particular features disclosed here and in the exemplary embodiments can each be implemented individually or in a combination.

In addition, methods according to the disclosure can be carried out particularly with dispensers and dispenser systems according to the disclosure. Dispensers and dispenser systems according to the disclosure can in particular be used to carry out methods according to the disclosure. Consequently, all of the disclosed embodiments of dispensers and dispenser systems simultaneously disclose corresponding dispensing methods and vice versa.

### BRIEF DESCRIPTION OF THE DRAWINGS

FIG. 1 schematically depicts a dispenser/reservoir combination according to the present disclosure.

FIG. 2 schematically depicts a dispenser according to the disclosure.

FIG. 3 schematically depicts a dispenser system according to the disclosure in a functional depiction.

FIGS. 4 and 5 schematically depict a guide system according to the disclosure, with a dispenser/reservoir combination according to the disclosure.

FIGS. 6a and 6b show a guide plate of a guide system according to the disclosure.

FIG. 7 schematically depicts another dispenser according to the disclosure in a functional depiction.

FIG. 8 schematically depicts another dispenser/reservoir combination according to the disclosure.

### DETAILED DESCRIPTION OF THE INVENTION

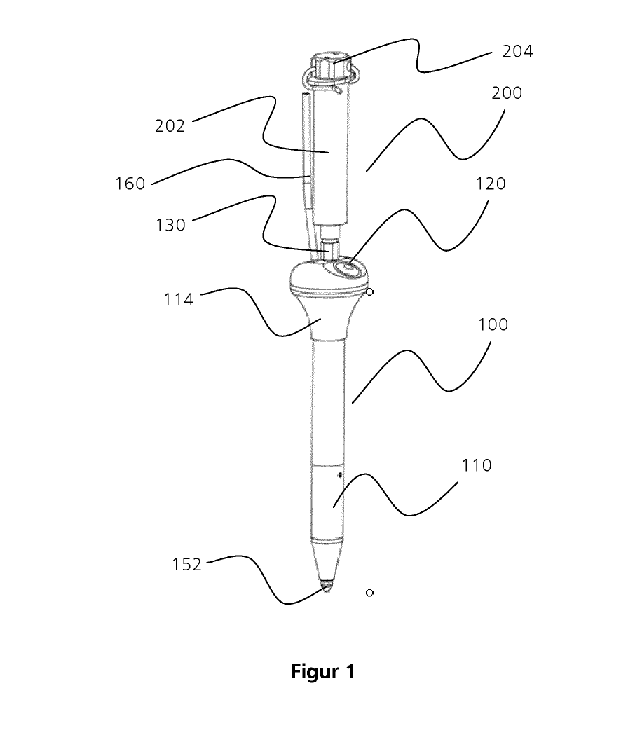

FIG. 1 schematically depicts a dispenser/reservoir combination with a dispenser 100 together with a connected reservoir 200, which stores the liquid that is to be dispensed by means of the dispenser 100.

The dispenser 100 has a pin-like or rod-like, essentially cylindrical dispenser housing 110 and a dispenser head 114. The dispenser housing 110 in this case is embodied so that in use, the dispenser housing 110—possibly by means of a plastic grip that is described in greater detail below—rests in the palm of the user's hand and is enclosed by the fingers from the index finger to the little finger and the dispenser 100 is supported in the axial direction with the concave form of the dispenser head 114 against the index finger. The attitude during use is the same as that which is known, for example, from electronic laboratory pipettes or so-called “pens” for injecting drugs.

The dispenser housing 110 can be optionally provided with a slipped-on plastic grip, for example made of PVC (not shown), which can be easily removed for cleaning or maintenance purposes. This plastic grip is used not only for improving the ergonomics and haptics, but also reduces the heating of the dispenser 100 and thus a possible thermal influence on experiments by the temperature of the hand. Depending on the application field and the framework conditions, it would be alternatively possible to provide a corresponding handle as a fixed component of the dispenser 100.

From an ergonomic standpoint, the plastic grip or also the dispenser 100 itself can be embodied so that they fit well in the user's hand and permit concentrated and relaxed work, even for longer periods of time.

A control element in the form of a button 120 for triggering dispensing commands is integrated into the dispenser head 114; the effective performance of the dispensing procedure additionally requires a control unit, as described further below. The positioning of the button 120 is essentially based on ergonomic factors and is preferably embodied so that the user can conveniently actuate the button 120 with his or her thumb, when the dispenser 100 is held in the intended fashion. There are also other possible embodiments in which the button 120 is designed, for example, to be operated with the index finger. In addition, the button 120 can also not be provided on the dispenser 100 itself. In such an embodiment, the dispensing command is issued, for example, by means of a foot switch.

At its top end, the dispenser 100 has a reservoir connector 130 for connecting to the reservoir 200. During operation, the reservoir 200 rests on the dispenser head 114. The reservoir 200 has a receptacle volume of typically between 2 and 20 ml. For example, disposable syringe barrels with a Luer Lock and a cylindrical reservoir body 202 are used for the reservoir 200. Alternatively, it is also possible to use glass syringe barrels with a Luer Lock or other proprietary reservoirs.

The reservoir 200 is affixed to the dispenser head 114 by means of a thread adapter, for example made of stainless steel.

At the upper end, the reservoir 200 is connected in a sealed fashion to a reservoir head 204, for example a metal stopper. A compressed air supply line (not shown) is conveyed through the reservoir head 204 via a screw-mountable plastic adapter (not shown) so that the compressed air supplied by means of the compressed air supply line exerts pressure on the liquid substance stored in the reservoir body 202. Depending on the use, it is also possible to position the reservoir 200 so that it is spatially separate from the dispenser 100 and to provide a liquid line, e.g. in the form of a thin tube, between the reservoir 200 and dispenser 100.

For example, the outlet of an electrical control line 160 for supplying energy to the dispensing valve is likewise located in the vicinity of the dispenser head 214, as described further below. The reservoir head 204 can also serve as a holder for the control line 160.

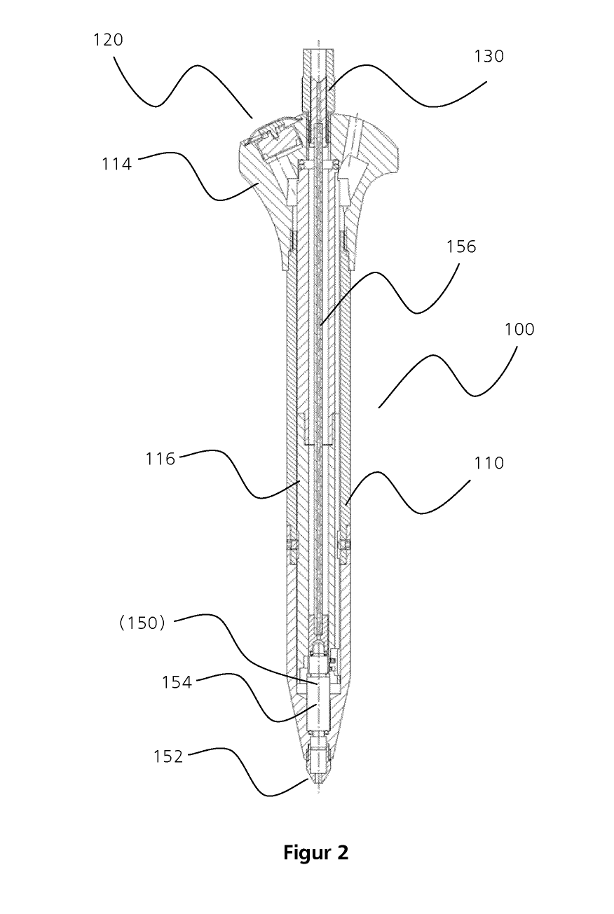

FIG. 2 schematically depicts the internal design of the dispenser 100 in a longitudinal section. The dispenser 100 includes a dispensing valve 150. The dispensing valve 150 is a passively closing microvalve and is embodied in the form of a ball valve according to the above disclosure. The inlet of the dispensing valve 150 is fluidically connected to the reservoir 200 via a connecting tube 156. The dispensing valve 150 is positioned coaxially inside the valve coil 154 and in the depiction according to FIG. 2, is enclosed by it.

The valve tip 152 is fluidically coupled to the outlet of the dispensing valve 150. It is conically shaped and forms an outlet conduit, for example approx. 2-3 mm long and with an internal diameter of approx. 1.5-2 mm. The length of the outlet conduit is advantageously limited to a value at which the liquid to be dispensed does not adhere to the conduit wall to any appreciable degree. The valve tip 152 is as narrow as possible at the tip. The conical shape and an embodiment of the valve tip 152 that is as sharp as possible make it easier to aim the hand-held dispenser 100, for example at the comparatively small wells of a conventional microplate or microtiter plate.

In addition, special positioning aids (not shown) can optionally be provided. A positioning aid of this kind can be embodied, for example, in the form of a contact edge by means of which the dispenser housing 110 or the valve tip 152 can be placed, for example, against the edge of a well or test tube. In addition, a positioning aid can project an optical targeting mark such as a spot of light or a cross, as is known, for example, from laser pointers.

The dispensing valve 150 is supported in a tubular inner valve holder 116 that is positioned coaxially inside the dispenser housing 110. The inner valve holder 116 can have a cable guide, for example in the form of a longitudinal groove in its outer circumference.

For actuating the dispensing valve 150, a valve coil 154 is provided, which is connected to the control cable 160 and wired in series with the button 120.

In an embodiment that is not mandatory but advantageous, the reservoir connector 130 is screw-connected to the connecting tube 156, just as the connecting tube 156 is screw-connected to the dispensing valve 150. In addition, the valve tip 152 can be screwed into the dispenser housing 110. In such an embodiment, the dispenser 100 can be disassembled so that all parts that come into contact with the liquid to be dispensed, including the dispensing valve 150, can be cleaned thoroughly and safely, and can be disinfected by means of autoclaving, for example. In an embodiment of this kind, the operational dispenser does not have any disposable parts.

Advantageously, after disassembly of the valve insert, the dispenser housing 110 with the still-installed valve coil 154 can also be washed, e.g. by rinsing, and can preferably also be disinfected. For this reason, the valve coil 154 can be hermetically cast.

The individual components of the dispenser 100 are advantageously made of materials that can be disinfected, for example by means of autoclaving, e.g. anodized aluminum, stainless steel, and/or suitable durable plastics.

Although a disinfection, for example by means of autoclaving, appears to be basically advantageous, this is not mandatory; moreover, other types of cleaning are also conceivable, for example by means of miniaturized round brushes soaked with a suitable cleaning liquid or disinfectant.

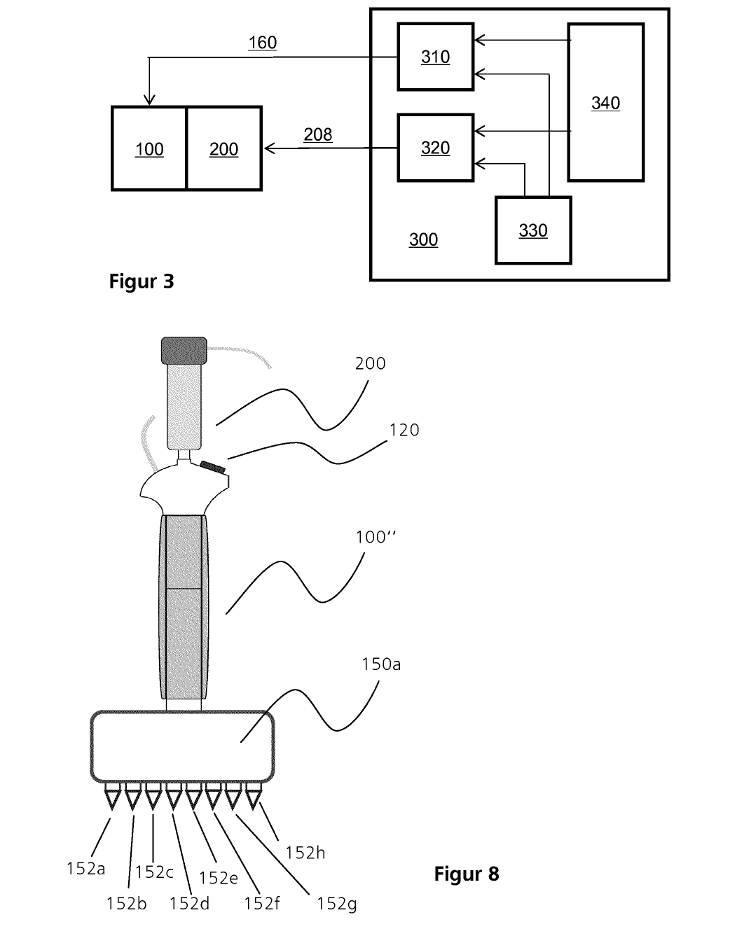

FIG. 3 shows an example of a dispenser system in a schematic functional depiction. The dispenser system includes a dispenser 100, a reservoir 200, and a control unit 300. The dispenser 100 can, for example, be a dispenser according to the depiction in FIGS. 1 and 2 and the associated description, but can also be a different dispenser according to the present disclosure.

For example, the control unit 300 includes a valve control 310, a compressed air supply 320, a power supply 330, and a control unit and operator control module 340. For operation, the valve control 310 is connected to the dispenser 100 via the control line 160 and the reservoir 200 is connected to the compressed air supply 320 via a compressed air supply line 208.

In the depiction in FIG. 3, the control unit 300 can be embodied in the form of a compact tabletop unit with a combined housing. Alternatively, however, it is also possible to produce the subassemblies, in particular the valve control 310 and compressed air supply 320, as separate devices.

For example, the power supply 330 is embodied as a power supply for connecting to the alternating current network, but can alternatively or additionally be based on rechargeable or non-rechargeable batteries.

The valve control 310 includes a driver stage for supplying power to the valve coil 154 and an internal clock or timer that controls the driver stage and can be used to preset the volume that is to be dispensed. Alternatively, the valve control can include a pulse generator or pulse shaper for multiple triggering of the dispensing valve in a sequence, as described above. The volume to be output can be set in analog or digital fashion by means of a control unit and operator control module.

The compressed air supply 320 can be embodied as a mechanical pressure regulator of a basically known design, which is supplied, for example, by an existing laboratory compressed air supply or an external air pump or compressor that is integrated into the control unit 300. The working pressure on the output side of the pressure regulators can be adjusted in the range from e.g. 0.1 bar to 1 bar manually, for example, independently of the advance pressure, i.e. the air pressure produced by the air pump or laboratory supply at the inlet of the pressure regulators (typically up to 5 bar). The working pressure is displayed in analog or digital fashion with a resolution of 0.01 bar, for example, and is advantageously recorded.

An adjustability of the working pressure is not mandatory, but can be advantageous to the extent that for the given design, the liquid volume (shot volume) that is output with each triggering action is determined along with it based on the viscosity of the liquid to be dispensed and based on the air pressure acting in the reservoir 200.

In order to electrically connect the dispenser 100 and control unit 300, the control line 160 can advantageously be equipped with a corresponding plug connector. In a modification, a plurality of dispensers 100 can alternatively be used on the control unit 300; the control unit 300 advantageously identifies the connected dispensers automatically by means of an identification device (not shown) of the control unit 300. To this end, the plug connector can simultaneously be used to transmit dispenser-identifying information, which for example by means of a mechanical coding that interacts with microswitches in the control unit 300, an electrical coding, or an RFID-Tag, which interacts with a reading device that is integrated into the control unit 300 as an identification device.

By identifying the dispenser, it is possible, for example, to automatically adapt the triggering of the valve coil 154 and/or of the supplied air pressure as a function of the viscosity of the liquid that is to be dispensed.

In another alternative embodiment, the control unit is designed for parallel connection of a plurality of dispensers.

In an elementary embodiment, the control unit 300 is only used to trigger and supply the dispensers 100. In other embodiments, the control unit 300 can perform additional functions. In particular, it is possible to store dispensing procedures together with parameters that are essential for documentation and/or test evaluation, in particular the respectively dispensed liquid volume and/or date and time as well as the working pressure for purposes of recording notes. If the control unit 300 is designed to identify various dispensers, then it is likewise possible to record the dispenser used and/or the respectively dispensed liquid. The stored values can be output, for example, by means of a display of the control unit and operator control module 340 or by means of a connected printer.

In addition, the control unit and operator control module can be designed for connection to a control computer, for example an external conventional personal computer (PC) and to this end, can have one or more corresponding interface(s), for example embodied in accordance with the conventional USB standard. Alternatively or in addition to a recording of the dispensing procedures, such an external computer also makes it possible to remotely control the valve control 310 and/or compressed air supply 320. Alternatively or in addition to one or more USB-standard interfaces, the control unit 300 can have other interfaces, for example according to the RS232 and/or Ethernet standard. Furthermore, additional auxiliary inputs and/or auxiliary outputs can be provided for additional or auxiliary functions, for example one or more additional compressed air outlets, binary or analog electrical outputs, analog electrical inputs for connecting additional sensors, etc. It is likewise possible to integrate a control computer entirely or partially into the control unit 300.

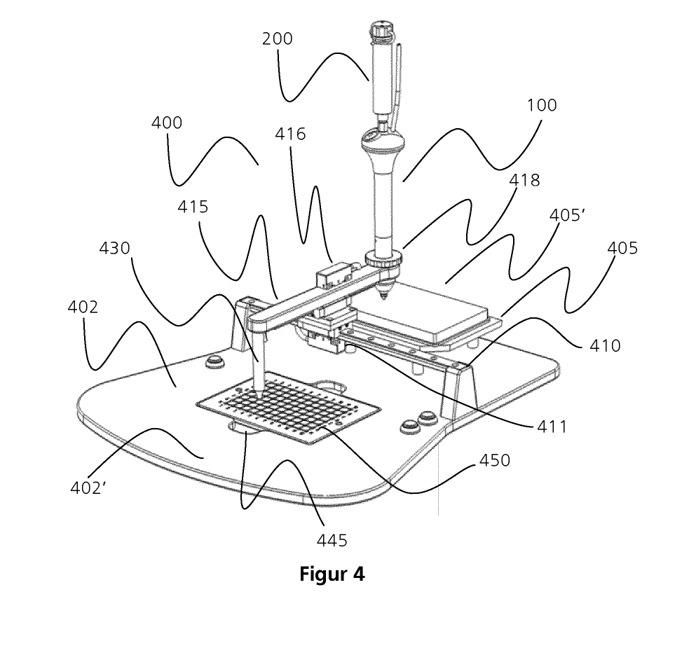

FIGS. 4 and 5 show a dispenser 100 with a reservoir 200 and a guide device 400. It is not mandatory, however, to use a hand-held dispenser 100 in connection with the guide device 400. It is likewise possible to use a dispenser with a different design, which is especially embodied, for example, for use with a guide device 400. In a design of this kind, the dispenser and the guide device 400 can also be embodied in a completely or partially integral fashion.

The guide device 400 has a base plate 402, which serves as a mounting platform for the additional components. The guide plate supports the additional components and ensures the stability of the overall structure.

A microplate holder 405 and an x/y guide mechanism with two linear axes 410 (x axis) and 415 (y axis) are mounted on the base plate 402. In addition, the base plate 402 has a recess 445 for accommodating a guide plate 450.

The microplate holder 405 serves to accommodate and to hold a conventional microplate or microtiter plate 405′ in a largely play-free, stationary fashion. The microplate holder 405 can in particular be designed for accommodating microplates or microtiter plates with 96 and/or 384 wells. The microplate holder 405 can be designed to accommodate wells 405′ in a landscape format, portrait format, or both. The microplate holder 405 thus constitutes an example of a dispensing target holder, with the individual wells of the microplate or microtiter plate 405′ constituting dispensing targets. Basically, the dispensing targets can be variable in shape and size.

The x axis 410 and the y axis 415 together constitute an essentially play-free, manually actuated set of Cartesian kinematics, which accommodates the dispenser 100 on the y axis 415 by means of a dispenser receptacle 418, for example by means of clamping and/or chucking, as is known, for example, from the accommodation of tools and work pieces in machine tools. The dispenser receptacle 418 can be correspondingly embodied for alternative forms of dispenser. The depicted implementation of the kinematics is intended as an example and can likewise be embodied differently. As a result, the roles of the x axis and y axis can be reversed. To the person skilled in the art, additional design embodiments of the kinematics ensue from known apparatuses such as robots or other positioning systems with Cartesian kinematics.

The guide mechanism holds the dispenser 100 at a constant height above the microplate 405′, without the tip of the dispenser dipping into the individual wells or the liquid contained in them.

The axes 110, 115 can be moved manually by exerting a small amount of force and thus permit a precise manual and/or mechanical positioning of the dispenser 100 over the dispensing targets, for example wells of the microplate 405′. The positioning and movement path of the axes 110, 115 can be dimensioned so that by moving the axes 110, 115, the dispenser 100 can be positioned over each well of the microplate 405′.

The x axis 410 and the y axis 415 have linear path measuring systems (length measuring systems) 111, 116 integrated into them, which detect the position of the dispenser 100—and in particular of its valve tip 152—in relation to the microplate 405′. The reading of the path measuring systems thus makes it possible to determine whether the valve tip 152 is situated over a well of the microplate 405′ and if need be, over which one.

The path measuring systems 111, 116 can, for example, be capacitive, optical or magnetic, and incremental or absolute path measuring systems of a basically known design. At least in the case of incremental path measuring systems, a device of a known design should be provided for determining at least one reference position such as an end stop of the relevant axis.

For example, the guide mechanism is embodied so that the y axis 415 extends from the x axis 410 in both directions, perpendicular to the x axis 410. For example, in a central position of the y axis 415, the x axis 410 can divide the y axis 415 approximately in the middle. The dispenser receptacle 418 is situated at one end of the y axis, as shown above. At the other end of the y axis 415 and thus on the other side of the x axis 410, a guide pin 430 extends down perpendicularly from the y axis 415 toward the base plate. In the operational state with an installed dispenser 100, the longitudinal axes of the guide pin 430 and dispenser 100 are correspondingly parallel.

In the region across which the guide pin 430 sweeps with the movement of the axes 110, 115, the base plate 402 has a recess 445, which is embodied to accommodate a guide plate 450 in an essentially play-free fashion and preferably flush with the upper edge of the base plate 402. The guide plate 450 in this case preferably fits precisely in the recess 445, for example, and by means of finger wells (no reference numeral), can be removed from the recess 445 and replaced. Other means for positioning, for example alignment pins and alignment bores, can also be provided.

The orientation of the guide plate 450 corresponds to that of the microplate 405′. In the example shown in FIG. 4, the microplate 405′ and guide plate 450 are each oriented in landscape format. In a likewise possible arrangement of the microplate 405′ in portrait format, the recess 445 is correspondingly also embodied to accommodate the guide plate 450 in portrait format.

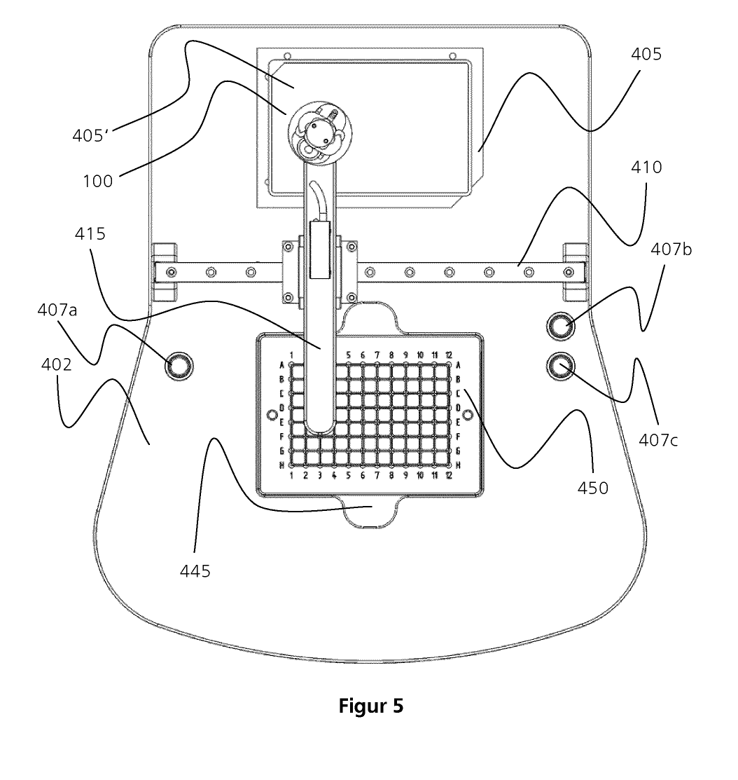

The design and function of the guide plate 450 are shown in FIGS. 6a and 6b. FIG. 6a shows a top view of the guide plate 450 by itself. FIG. 6b shows a perspective view of the guide plate 450, inserted into the recess 445 of the base plate 402, together with the section of the guide pin 430 oriented toward the guide plate 450.

The guide plate 450 has a grid of concave elements in the form of recesses or blind holes 452. A recess or blind hole 452 is provided for each well of the microplate 405′; the distance between the centers of the wells corresponds to the distance between the centers of the recesses or blind holes 452. In one exemplary embodiment, the guide plate 450 is reversible, the one side being designed for microplates with 96 wells (shown in FIGS. 6a and 6b) and the opposite side being designed for microplates with 384 wells. For use with other types of microplates, it is possible to use correspondingly adapted guide plates 450. In the exemplary embodiment shown, the recesses or blind holes 452 are connected by means of guide grooves 454, 456 arranged in rows and columns, which correspond to the x direction and y direction. To facilitate orientation and navigation, the rows and columns can be labeled, for example by means of engraved numbers 458 and letters 458′.

As is shown in FIG. 6b, the end of the guide pin 430 oriented toward the guide plate 450 is embodied in the form of a tapering guide journal 432. A guide ball 434 situated at the end of the guide journal 432 is advantageously supported with a spring action in the axial direction. Alternatively, the entire guide journal 432 or guide pin 430 could also be embodied with a spring action in the axial direction.

The diameter of the guide ball 434 is dimensioned so that the guide ball 434 can slide in an essentially play-free and frictionless fashion in the guide grooves 454, 456 and when traveling over one of the recesses or blind holes 352, can engage in and disengage from it in an essentially play-free fashion by means of the spring-action support. In order to guarantee a low-force, jolt-free engagement, the recesses or blind holes 452 are advantageously provided with corresponding bevels.

During operation, the user guides the guide pin 430 across the guide plate 450, with the guide ball 434 being guided in the grooves 454, 456. As a result of this, the movement is restricted to linear movements in the x direction and y direction, with the distance between adjacent paths in both directions corresponding to the distance between the wells on the microplate 405′. When it travels over recesses or blind holes 452, the guide ball 434 engages in them easily. The correspondence between the guide plate 450 and the microplate 405′ enables a precise placement of the dispenser 100 above the individual wells of the microplate 405. The arrangement of the dispenser holder 418 and guide pin 430 on the y axis 415 is dimensioned and adjusted so that each respective engagement position on the guide plate 450 exactly matches the corresponding position of the microplate 405′.

In an alternative embodiment, the guide plate 450 has convex elements instead of concave elements, for example in the form of raised areas, while the guide pin has a corresponding concave element.

In a region 402′ next to the guide plate socket 445, the base plate 402 can be embodied as a hand rest surface in order to enable precise, non-fatiguing work even for long periods of time.

Advantageously, the movement and positioning of the dispenser 100 is carried out by moving the guide pin 430, as a result of which the dispenser 100 is correspondingly also moved due to the mechanical coupling. It is therefore not necessary for the user to access the dispenser 100 itself.

To improve ergonomics, it is therefore possible for an additional grip-optimized handle (not shown) to be provided, which encompasses the guide pin 430 entirely or partially or can also be provided on it above the y axis 415. For an ergonomic embodiment, this handle can also include a button that can be used to trigger dispensing procedures as an alternative to the button 120 on the dispenser 100.

A guide device with a detent mechanism, which permits a reliable, preferably detent-engaging positioning of the dispenser 100 over the wells, can also be implemented in a different way in lieu of the implementation by means of a guide pin 430 and guide plate 450 that is shown by way of example. It is thus possible, for example, to embody the guides of the x axis 410 and y axis 415 so that they immediately engage at the spacing of the wells. Particularly in connection with a corresponding computer-aided evaluation of the path measuring systems 411, 416, as described further below, it is also possible if need be to eliminate a detent function of the guide mechanism. In a simple embodiment, the microplate holder 405 can be rigidly mounted to the base plate 402. It is, however, also possible to provide a microplate shaker that is able to shake the microplate, for example by means of a vibration motor. In the spirit of a modular design, it is possible to provide an interchangeable rigid microplate holder and an interchangeable microplate holder with a shaker.

Shakers are well known in the field of chemical laboratory technology; in terms of the design and the movement pattern (shaking pattern) that can be implemented, a wide variety of them is available. For the integration into the microplate holder, the primary option to be considered is a simple, inexpensive design that can produce a shaking—for example with an adjustable frequency—in the range between approximately 300 and 3000 vibrations per minute. The frequency adjustment in this case can be carried out manually or in a software-aided way as described below. The shaking function can easily be switched on and off by means of a foot switch or a button 407b, 40c (sic) that is integrated into the base plate. Another button 407a can be provided, for example also for triggering dispensing procedures.

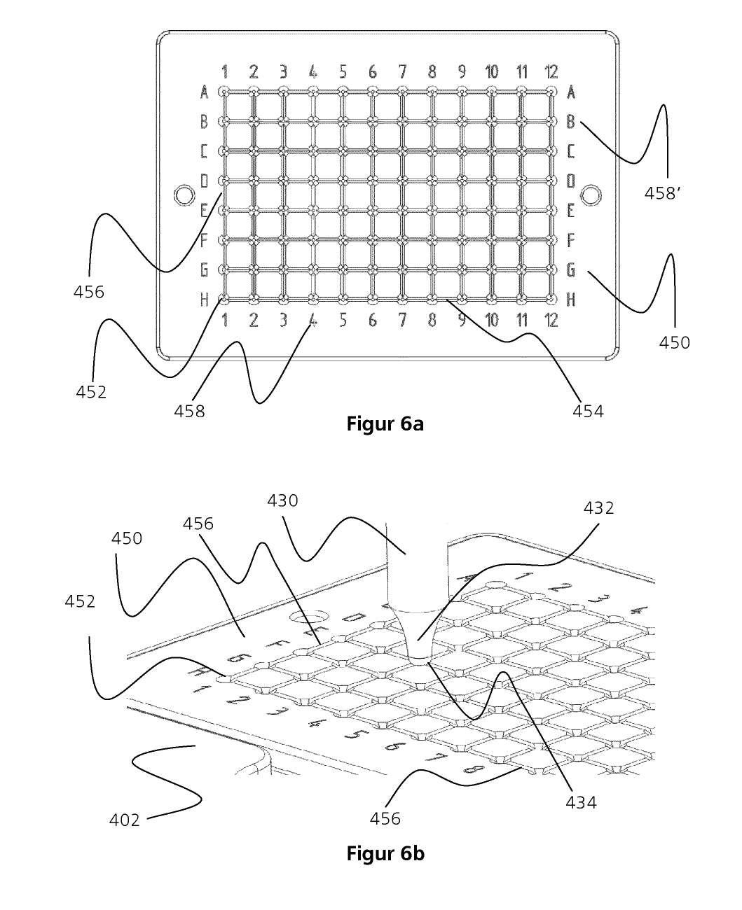

FIG. 7 shows another exemplary embodiment for a dispenser system according to the present disclosure. The dispenser system shown includes two dispensers 100, 100′ with associated reservoirs 200, 200′. In the following, it is assumed that the dispenser 100 is a hand-held dispenser, as shown, for example, in FIGS. 1 and 2, and is used without additional accessories. For example, it is also assumed that the dispenser 100′ is such a dispenser, but which is used with the reservoir 200′ together with a guide device 400, thus producing a configuration according to FIGS. 4 through 6. As mentioned above, however, the dispenser 100′ can also be embodied especially for use with the guide device 400 or can comprise an integral unit with it.

As in FIG. 3, the depiction in FIG. 7 uses essential functional units or blocks. In the practical technical implementation, individual blocks can be implemented by means of a plurality of components; likewise, various functional units or blocks can be implemented by means of identical structural components or subassemblies. Basically, the control unit 300′ can be constructed in a fashion similar to that of the control unit 300 and can perform some or all of the optional functions embodied in connection with the control unit 300.

Naturally, the dispenser system can also include only one dispenser 100′, or can be provided with more than two dispensers, for example three or four dispensers, either connected in parallel to the control unit 300′ or optionally, an automatic differentiation or identification of the dispensers can take place for example by means of plug connectors as described in connection with FIG. 3.

The exemplary dispenser system according to FIG. 7 includes a control unit 300′ and a control computer 600, for example an external personal computer (PC) suitable for use in the laboratory, with corresponding control software as described below. It is, however, also basically possible to integrate the functionality of the control computer 600 entirely or partially into the control unit 300′.

Since a system according to FIG. 7 makes it possible to perform comparatively complex functions, it is preferable to provide a convenient display and corresponding control element. The display can be composed, for example, of a conventional flat-panel display, which can be mounted, for example, to the base plate 402 on or above the guide device e.g. with a ball-and-socket joint. The display screen can also optionally be embodied as a touch screen and can thus simultaneously provide necessary control elements.

Like the control unit 300 in FIG. 3, the control unit 300′ can include a power supply, which is not shown for the sake of clarity. As is immediately clear from FIG. 7, the control unit 300′ serves as an interface between a control computer 600 on the one hand and the dispensers 100, 100′, a guide device 400, and possibly a microplate shaker on the other.

In the embodiment shown in FIG. 7, the compressed air supply 320 serves to act on both reservoirs 200, 200′ with a combined pressure. It is also possible, however, to provide separate and for example separately controllable compressed air supplies for the individual dispensers. This can make sense, for example, if the different dispensers dispense media with significantly different viscosities. Furthermore, separate shut-off valves and an exhaust valve (respectively not shown) can also be provided for different compressed air outlets.

The valve control 310′ associated with the dispensers 100′ is embodied essentially identically to the valve control 310 associated with the dispensers 100.

The control unit 300′ also includes an evaluation system 351 for the path measuring system 311 of the x axis and an evaluation system 352 for the path measuring system 316 of the y axis; each path measuring system 311, 316 and its associated evaluation system 351, 352 are operatively coupled, for example via corresponding lines. The evaluation systems 351, 352 evaluate the signals transmitted by the path measuring systems 411, 416 such as binary pulse sequences and provide corresponding path signals. Alternatively, the evaluation systems 351, 352 can also be integrated completely or partially into the path measuring systems 411 or 416. Typically, the evaluation systems 351, 352 are implemented by means of analog and/or digital circuits that are adapted to the path measuring systems 411, 416.

The control unit 300′ also includes an optional triggering circuit 360 for the shaker 500, by means of which the shaker 500 can, for example, be switched on and off and/or its frequency can be set by the control unit 300′.

The control unit 300′ also includes a control unit and operator control module 340′, which is coupled to the other functional units of the control unit 300′. In particular, the control unit and operator control module controls the valve controls 310, 310′ and optionally, the compressed air supply 320 and the triggering circuit 460 for the shaker 500. In addition, the control unit and operator control module 340′ receives the path signals of the evaluation systems 351, 352 and relays them, for example, to the control computer 600.

The function of the control unit and operator control module will be described below together with the control computer 600 and the corresponding software.

During operation, the coordinates detected by the path measuring systems 111, 116 are detected in an essentially continuous fashion and are conveyed via the control unit 300′ to the external computer 600. The external computer 600 compares the thus-transmitted actual position of the dispenser 100′ to coordinates of the individual wells on the microplate 405′ that are stored in a coordinate map. The individual wells in this case constitute metering targets while their openings—or more precisely, the centers of their openings—constitute corresponding target positions. Since the microplates are basically standardized and the physical position of the microplate 405′—and therefore of the individual wells—is certain based on the design, the coordinate association is generally applicable to a type of microplate.

The volumes to be dispensed from the reservoir 200′ into the wells by means of the dispenser 100′ are stored in a metering plan that is established for example by manual input or that is read from a file. Depending on the application, it is possible to dispense the relevant substance into only some of the wells and/or for different volumes to be dispensed into different wells of the same microplate 405′. In general, the metering plan can thus contain specific volume data for each of the for example 96 or 384 wells. The output of the correct volume occurs automatically as the dispensing is carried out, as illustrated above, through corresponding triggering of the valve coil of the dispenser 100′.

As demonstrated above, the movement toward the wells and preferably also the triggering of a dispensing command are carried out manually by the user. A triggering of the valve coil in the dispenser 100′ and thus an actual dispensing from the reservoir 200′, however, only occurs if at the moment the dispensing command is triggered, e.g. by actuating the button 120, the actual position is a target position, i.e. the valve tip is situated above a well into which a dispensing is actually to be carried out according to the metering plan.

If the valve tip of the dispenser 100′ is not situated over a well, then the actual position is not a target position. Consequently, no power is supplied to the valve coil and therefore no dispensing occurs in reaction to a dispensing command.

Preferably, a target position also does not exist if the valve tip of the dispenser 100′ is in fact situated above a well and thus a basically possible target position, but a dispensing of the relevant substance into this well has already taken place.

On a display such as a display screen, the control computer 600 at least schematically depicts a view of the microplate 405′, with each well being represented, for example, by a circle. In such a depiction, a well over which the dispenser is currently situated can be indicated, for example by highlighting the well in color. In a comparable fashion, a depiction can be provided indicating the wells into which a substance has yet to be dispensed, i.e. which wells are valid dispensing targets, and/or which wells a substance has already been dispensed into.

In one such embodiment, a correct execution of dispensing procedures must also be ensured when the operator's work has been interrupted in the meantime. In the same way, the correct execution is not in principle bound to a particular sequence of wells to be approached.

Preferably, the control unit 300′ and/or the control computer 600 also carries out a recording of the dispensing procedures, as demonstrated above.

In numerous applications, different substances must be dispensed one after the other. To this end, the software on the control computer 600 can store a respective metering plan for each of the individual substances; the metering plans are processed by the user one after the other. In this case, the individual substances can be executed one after the other in a dispenser 100′ by changing the reservoir 200′ with a cleaning or rinsing between procedures. Alternatively, there can be separate dispensers for the respective individual substances that are introduced into the dispenser receptacle 418 one after the other. For rinsing without removal of the dispenser 100′ from the dispenser receptacle 418, a sink (not shown in the FIGS.) can be provided on or in the base plate 402.

Depending on the embodiment of the software, the creation of one or more metering plans can also be completely or partially automated. It is thus possible, for example, to provide program routines for creating metering plans for the following functions: dispensing an identical volume into several or all of the wells; standardization; series, in particular linear, quadratic, or logarithmic series, in which the volume to be dispensed is determined between the wells according to a corresponding functional interrelationship.

The control computer 600 and/or the control unit 300′ can also be designed to perform teach-in programming. In this case, a metering sequence is carried out manually and for example without a previously established metering plan by means of dispenser 100 or 100′. In this case, the sequence is stored and is then available as a metering plan for subsequent studies or experiments. Likewise, the metering plan thus established can also be transferred to other dispensing systems, for example dispensing automats or dispensing robots.

When creating the metering plan in this way by means of teach-in programming, it is also not necessary for an actual metering to take place during the teach-in process and for the positions at which a metering is to be carried out to be merely approached and recorded.

In addition, the guide device 400 shown in FIGS. 4 and 5 can optionally be equipped with an electrical drive (not shown) by which, for example by means of two motors, the linear axes 410, 415 can be moved in a motorized way. The control computer 600 and/or the control unit 300′ is/are then advantageously equipped with interfaces for triggering the electric drive. In such an embodiment, a metering plan that is created in the above-described way by means of teach-in programming can then be executed repeatedly and in an automated fashion, the movement of the dispenser 100′ being carried out by means of the electric drive in the automated embodiment.

In addition, the software on the control computer 600, can optionally perform a randomization when establishing metering tables with different volumes to be dispensed into each well. In addition the software can perform auxiliary functions. These can, for example, include: a rinsing function of the dispenser 100′ for the successive dispensing of different substances; a calibration function for calibrating the output quantity for a particular substance to be dispensed.

The determination of the dispenser position by means of path measuring systems 411, 416—in connection with the control unit 300′ and correspondingly adapted software on the control computer 600—also makes it possible for there to be alternative embodiments of the guide device 400. In particular, it is basically possible to omit the guide pin 430 and the guide plate 450, yielding a more compact design, but this eliminates the detent positions that correspond to the wells. The actual position of the dispenser 100′ in this case can be displayed together with the display screen image of the microplate, for example by means of a cross or the like. If the dispenser 100′ is situated in a target position, the corresponding well can be marked or highlighted as described above. In an embodiment of this kind, a particular tolerance area around the center point of the wells is preferably defined for each of the individual target positions and the valve tip is permitted to be within this tolerance area when dispensing the substance. In a modification, the axes 410, 415 can each be provided with an electrically actuated—for example electromagnetic—brake, which is triggered by the external computer 600 and the control unit 300′; when the brake is released, the movement of the axes 410, 415 occurs in a continuous, smooth fashion and when the brake is activated, this movement meets with significant resistance or is prevented. The triggering in this case occurs so that the brakes are released for the positioning of the dispenser 100′ and are automatically activated when the actual position of the dispenser 100′ corresponds to a target position. The brakes can be released automatically or also manually after completion of the corresponding dispensing procedure.

An optionally provided microplate shaker 500 can operate continuously or can be switched on and off manually by the user, as described above. It can, however, also be triggered by the control computer 600 by means of software and for example, the activation of the microplate shaker 500 is automatically synchronized with the execution of the dispensing procedures. For example, the microplate shaker 500 can be activated or switched on when the actual position of the dispenser 100′ corresponds to a target position and deactivated or switched off again, for example in a time-controlled fashion, after the dispensing is complete.

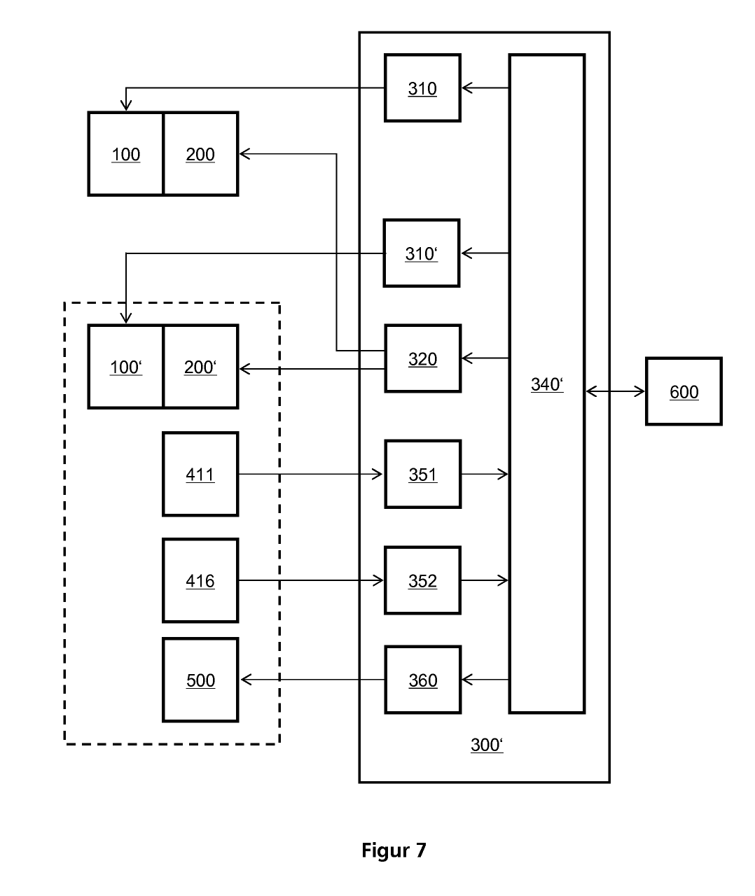

FIG. 8 is a purely schematic depiction of a dispenser, which can be used in a hand-held fashion or likewise together with a guide mechanism. The dispenser 100″ according to FIG. 8 is embodied in a way that is basically similar to that of the dispenser 100 according to FIGS. 1 and 2. Instead of a single valve insert 150, though, in the dispenser according to FIG. 8, a plurality of valve holders 150 is provided, whose interior (not visible in FIG. 8) contains a valve bank with a number of e.g. microvalves of the type shown in connection with the dispenser 100. In accordance with the number of valves, a valve tip 152a . . . 152h is provided for each valve on the multiple valve holder 150a, each of which executes a metering. The valves are each fed from the reservoir 200.

With an arrangement according to FIG. 8, an identical substance can be dispensed into a plurality of wells in parallel in a single procedure. For parallel metering of identical volumes, the individual valves can be triggered in parallel. It is also possible, however, to trigger the individual valves separately and to thus simultaneously meter different volumes.

1. A dispenser (100, 100′, 100″) for dispensing liquids, preferably liquid substances, in particular with volumes in the nanoliter range or microliter range, including:
a) a generally rod-shaped housing (110) and adapted to be held and used in one hand by a user;
b) a reservoir connector (130) for fluidically connecting a reservoir (200) that contains a liquid that is to be dispensed,
c) a triggering element (120) for manually triggering a dispensing command;
d) an electronically actuated dispensing valve (150) that has an open state and a closed state; the dispensing valve (150) has an inlet, which is fluidically connected to the reservoir connector (130), and an outlet; the dispensing valve (150) to convey the dispensing liquid from the inlet to the outlet in the open state;
e) a valve tip (152) fluidically coupled to the outlet of the dispensing valve (150) or constitutes part of the dispensing valve (150), the valve tip (152) to dispense liquid from the dispenser (100, 100′, 100″) in the open state of the dispensing valve (150).

2. The dispenser (100, 100′, 100″) according to claim 1, wherein the dispensing valve (150) comprises a passively closing ball valve with a valve seat made of a mineral material and a valve ball made of a mineral material.

3. The dispenser (100, 100′, 100″) according to claim 1, wherein the dispensing valve (150) is embodied for a minimal dispensing volume in the range from 10 to 200 nanoliters.

4. The dispenser (100, 100′, 100″) according to claim 1, wherein the elements that come into contact with the substance to be dispensed (150) can be removed without destroying them and reinstalled again.

5. The dispenser (100″) according to claim 1, wherein the dispenser includes a number of dispensing valves and a corresponding number of valve tips (152a, 152b, 152c, 152d, 152e, 152f, 152g, 152h).

6. The dispenser according to claim 1, including a (200) reservoir to contain the substance to be dispensed, wherein the reservoir (200) includes a connection for acting on the contained substance with compressed air.

7. A guide device (400) for a dispenser, in particular a dispenser (100, 100′, 100″) according to claim 1, the guide device (400) including:
a) manually actuated kinematics (410, 415) with a dispenser receptacle (418);
b) a dispensing target holder (405) for supporting a plurality of adjacent dispensing targets (405′) in a generally stationary, play-free fashion relative to the kinematics (410, 415), wherein the kinematics (410, 415) hold the dispenser and in particular a valve tip (152) of the dispenser (100, 100′, 100″) spaced a certain distance above the dispensing target holder (405′); and
c) a position sensor system (411, 416) for electronically detecting an actual position of the dispenser (100, 100′, 100″)—and in particular of a valve tip (152) of the dispenser in a plane—above the dispensing target holder (405).

8. The guide device (400) according to claim 7, wherein the manually actuated kinematics include manually actuated Cartesian x/y kinematics having an x axis (110) and a y axis (115) and the position sensor system (411, 416) includes a respective linear path measuring system for the x axis (410) and for the y axis (416).

9. The guide device (400) according to claim 7, wherein the dispensing target holder (405) comprises a microplate holder or microtiter plate with a number of wells, said wells constituting dispensing targets.

10. The guide device (400) according to claim 7, including a detent mechanism (430, 450) that engages when the dispenser—in particular a valve tip of the dispenser—is positioned above a dispensing target.

11. The guide device (400) according to claim 10, wherein the detent mechanism (430, 450) includes a guide pin (430) and a guide plate (450); the guide plate (450) includes a number of concave elements (452) whose geometrical arrangement on the guide plate (45) corresponds to the geometrical arrangement of the dispensing targets; and the guide pin (430) is designed so that when positioning over a concave element (452), the pin engages in the concave element and in the engaged state, releasably blocks or impedes a movement of the kinematics (410, 415).

12. The guide device (400) according to claim 7, wherein the guide device (400) includes an electric drive operatively coupled to the manually actuated kinematics (410, 415) for moving or driving the dispenser receptacle.

13. A dispenser system, including a dispenser (100, 100′, 100″) according to claim 1 and a guide device (400) according to claim 7.

14. A dispenser system, including at least one dispenser (100, 100′, 100″) according to claim 1, as well as a control unit (300, 300′), wherein the control unit (300, 300′) is embodied for operative coupling, in particular grid-bound coupling, to the at least one dispenser (100, 100′, 100″); the control unit (300, 300′) includes at least one valve control (320, 320′); and the at least one valve control (320, 320′) is embodied to actuate the dispenser valve (150) to output a dispensing volume that is preset by means of the control unit (300, 300″).

15. The dispenser system according to claim 14, wherein the control unit (300, 300′) is set up for connecting to a plurality of dispensers (100, 100′, 100″) and the control unit (300, 300′) includes an identification device for identifying a connected dispenser (100, 100′, 100″).

16. The dispenser system according to claim 14, also including a guide device according to claim 7, wherein the dispenser system includes a control computer (600); the control unit (300′) and the control computer (600) include an evaluation system (451, 452) for data transmitted by the position measuring system (411, 416); and the control unit (300′) and control computer (600) are embodied to compare the actual position of the dispenser—and in particular of a valve tip (152) of the dispenser—to one or more target positions and to perform an actuation of the dispensing valve (150) by supplying power to the valve coil (154) only when the actual position is a target position.

17. A method for dispensing liquid substances, in particular with volumes in the nanoliter range or microliter range, by means of a dispenser (100, 100′, 100″) in at least one target position, said method including:
a) manual positioning of the dispenser (100, 100′ 100″);
b) triggering of a dispensing command;
c) determining an actual position of the dispenser (100, 100′, 100″) and in particular of a valve tip (152) of the dispenser (100, 100′, 100″);
d) comparison of the actual position to the at least one target position;
e) triggering of a dispensing procedure in reaction to the metering command only if the actual position of the valve tip is a target position.

18. The method according to claim 17, including a display, in particular a graphic display, of the at least one target position and/or of the actual position.

19. The method according to claim 17, including the calling up of a volume that is to be dispensed at the at least one target position and the actuation of the dispenser (100, 100′, 100″) to dispense this volume.
